(19) United States
(12) Patent Application Publication
(10) Pub. No.: US 2025/0135872 A1
(43) Pub. Date: May 1, 2025

(54) POWER DISTRIBUTION CENTER THERMAL MANAGEMENT SYSTEM USING ACTIVE AIR DAM

(71) Applicant: FCA US LLC, Auburn Hills, MI (US)

(72) Inventor: Shu Wang, Lake Orion, MI (US)

(21) Appl. No.: 18/494,130

(22) Filed: Oct. 25, 2023

(51) Int. Cl. B60K 11/08; B60W 20/50; B60W 30/184

(52) U.S. Cl. CPC B60K 11/085; B60W 20/50; B60W 30/1843; B60W 2510/068; B60W 2510/087; B60W 2710/088

(57) ABSTRACT

A method and system for controlling a vehicle includes determining a temperature of a power distribution center and controlling an opening of an active air dam in response to the temperature of the power distribution center.

### FIELD

The present disclosure relates to a power distribution center in a hybrid vehicle and, in particular, to systems and methods for controlling the temperature of the power distribution center based on controlling an active air dam.

### BACKGROUND

This section provides background information related to the present disclosure which is not necessarily prior art.

Hybrid vehicles comprise an electrified powertrain containing a power distribution center. The power distribution center is connected to high voltages and carry high currents that generate significant ohmic heat which increases the temperature of the cable and connectors associated with the power distribution center and the power distribution center itself. Further, ambient temperatures contribute to the heat associated therewith. Additional heat is generated in hybrid vehicles by the internal combustion engine and exhaust. When high voltage cables, connector and the power distribution center are exposed to heat, this may reduce the life thereof.

### SUMMARY

This section provides a general summary of the disclosure, and is not a comprehensive disclosure of its full scope or all of its features.

In one example of the present disclosure, a method for controlling a vehicle includes determining a temperature of a power distribution center and controlling an opening of an active air dam in response to the temperature of the power distribution center.

In another example, a control system for controlling an active air dam includes a power distribution center and a controller operable to determine a temperature of the power distribution center and control an opening of an active air dam in response to the temperature of the power distribution center.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A is a top view of the vehicle having a power distribution center.

FIG. 1B is a side view of the vehicle of FIG. 1A.

FIG. 1C is a schematic view of a power distribution center having connectors thereon.

FIG. 2 is a view of the vehicle controller for controlling the vehicle air dam.

FIG. 3 is a flowchart of a method for controlling the position of the vehicle air dam.

Corresponding reference numerals indicate corresponding parts throughout the several views of the drawings.

### DETAILED DESCRIPTION

Example embodiments will now be described more fully with reference to the accompanying drawings.

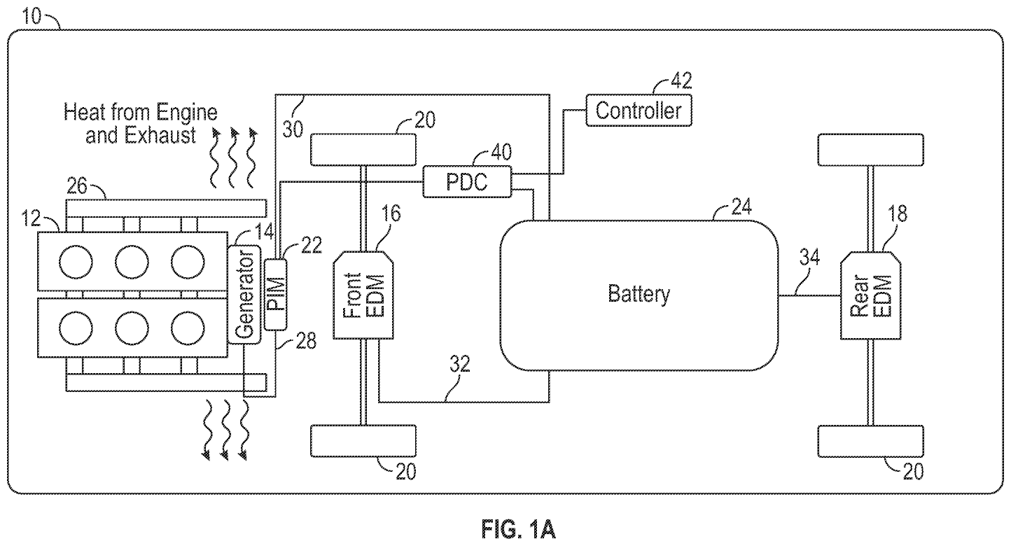

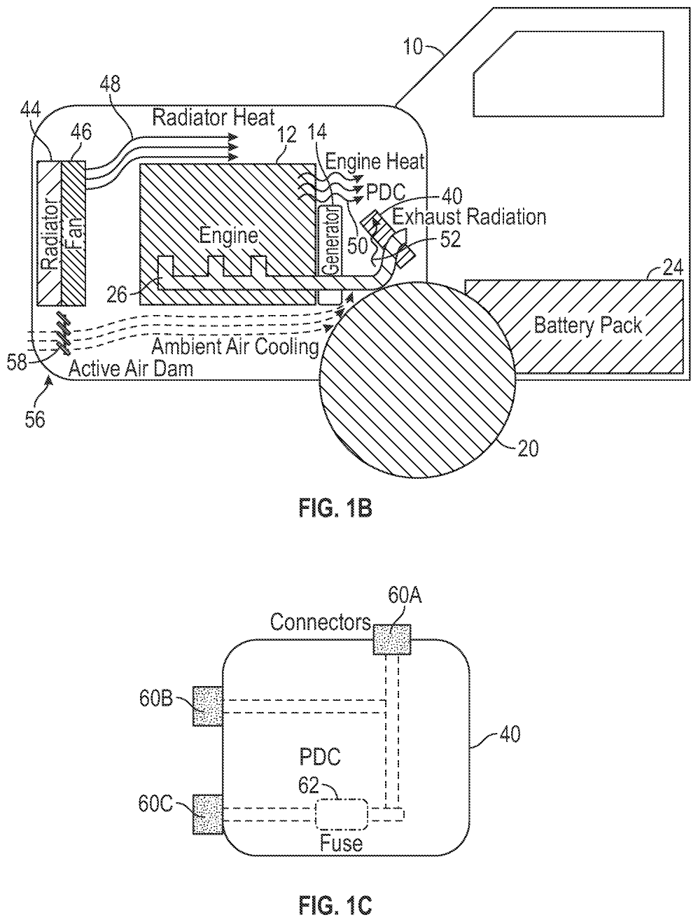

Referring now to FIGS. 1A and 1B, a high-level block diagram of a vehicle 10 is depicted. Examples of a type of vehicle include, but are not limited to, internal combustion vehicle, hybrid electric vehicle (HEV) and plug-in hybrid electric vehicle (PHEV).

In the depicted example, the vehicle 10 comprises an internal combustion engine 12, a generator 14, a front motor 16, which may be referred to as a front electric drive motor (EDM), and a rear motor 18, which may be referred to as a rear electric drive motor. The front motor 16 and rear motor 18 are connected to and provide motive power to the wheels 20. More than two EDMs such as two rear motors, two front motors or two front motors and two rear motors are other examples. In this example, the engine 12 is not mechanically connected to the wheels 20, but in other examples the engine 12 is mechanically connected to the wheels 20 through a transmission and provides motive force to the wheels 20. The engine 12 is connected to the generator 14 which produces electrical energy for the powertrain from the mechanical energy produced by the engine 12. Though the illustrated example is shown as a series powertrain layout, a parallel powertrain layout may also be used.

The generator 14 is electrically coupled to the power inverter module 22 by a HV cable 28. In one example, the HV cable is a single cable. In another example, the HV comprises one or more cables. The generator 14 provides electrical energy to the power inverter module 22 through the HV cable 28. The power inverter module 22 is connected to the battery 24 by an HV cable 30 and provides electrical energy to the battery 24 through the HV cable 30. The front motor 16 is connected to the battery 24 by an HV cable 32 and receives electrical energy from the battery though the HV cable 32. The rear motor 18 is connected to the battery 24 by an HV cable 34 and receives electrical energy from the battery though the HV cable 34.

The vehicle 10 also includes a power distribution center 40. The power distribution center (PDC) 40 is coupled to the battery and may also be coupled to the power inverter module 22. The power distribution center 40 is used for controlling the power and distributing the power to the various devices within the vehicle 10. A controller 42 may be coupled to the power distribution center 40. However, the controller 42 may be part of a vehicle controller or a portion thereof. The vehicle controller 42 may be one of several microprocessors coupled together to perform various functions within the vehicle 10.

The vehicle 10 may also include a radiator 44 that has a radiator fan 46. The radiator fan 46 has a fan speed that is controlled based upon the temperature of the engine. The radiator fan 46 also generates heat 48. The engine 12 also generates heat 50. The heat 48 from the radiator 44 and the engine heat 50 together with exhaust radiation 52 may all be imparted on the power distribution center 40. As illustrated, the power distribution center 40 is between the generator 14 and the battery pack 24.

Referring specifically to FIG. 1B, the engine 12 that radiates a high temperature and produces high temperature exhaust gases that are routed through exhaust pipes 26. The generator 14, power inverter module 22, and the connected HV cable 28 are in close proximity to the engine 12 and exhaust pipes 26 connected to the engine 12. The closeness at different points depends on various packaging constraints for the particular vehicle. The high temperature of the engine 12 and the high temperature radiating from the exhaust pipes 26 connected to the engine 12 affect the temperature of the power distribution center 40 as the adjacent high temperature of an engine 12 and the exhaust pipes 26 connected to the engine 12 can exceed the thermal limits of power distribution center 40.

An active air dam 56 has louvers 58 that may be open, closed or partially opened or closed based on a control signal from the

Referring now also to FIG. 1C, the power distribution center 40 may be affected by the various types of heat radiation such as the radiator heat 48, the engine heat 50 and the exhaust radiation 52. Also, the connectors 60A-60C of the power distribution center 40 may also be affected by the radiated heat. In particular, the connectors 60A-60C are sensitive to high heat. Such connectors 60A-60C are often formed from various types of polymers and therefore may crack or become brittle under high heat. Shorting can occur when cracks form in the connector and moisture enters.

The power distribution center 40 also has a fuse 62. The fuse 62 may also be sensitive to high temperatures.

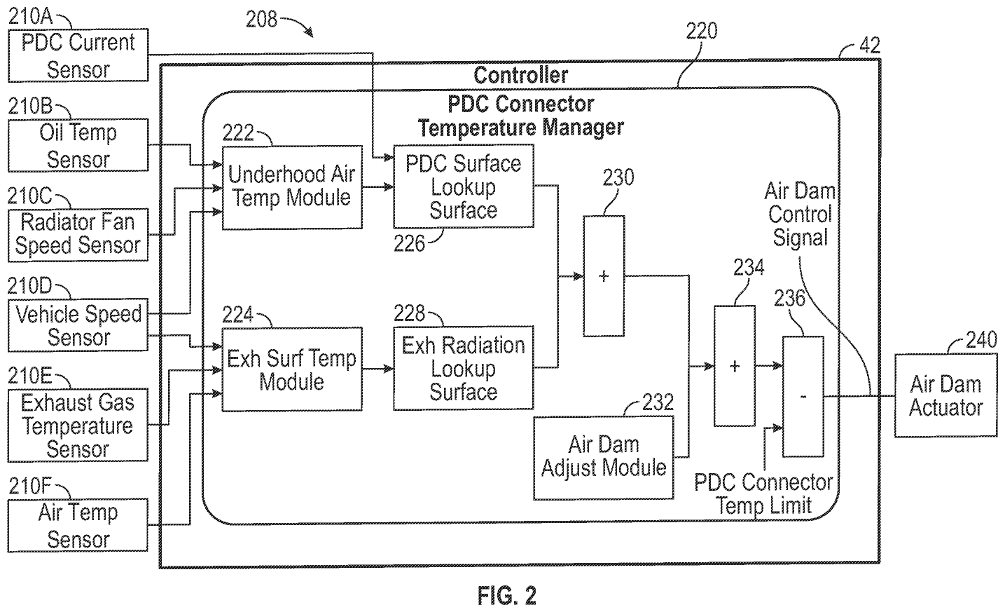

Referring now to FIG. 2, details of the vehicle controller 42 are set forth as part of a control system 208 for controlling the air dam 240. The vehicle controller 42 may include various functions. The controller 42 may be coupled to various sensors including a power distribution center current sensor 210 that generates a current signal corresponding to the current in the power distribution center 40, an oil temperature sensor 210B generating an oil temperature signal corresponding to the temperature of the engine oil. A radiator fan speed sensor 210C generating a radiator fan speed signal corresponding to the speed of the fan 46 of the radiator 44, a vehicle speed sensor 210D generating a vehicle speed signal corresponding to the vehicle speed, an exhaust gas temperature sensor 210E generating an exhaust gas temperature signal corresponding to the temperature of the exhaust gas at some point within the exhaust 26. One suitable location for the exhaust gas temperature sensor 210E is before a catalyst but after the engine manifold.

An air temperature sensor 210F may also be incorporated into the system 208. The air temperature sensor 210F generates an air temperature sensor corresponding to the air of the vehicle. The air temperature sensor 210F may be the temperature of the air adjacent to the vehicle or under the vehicle.

A power distribution center (PDC) connector temperature manager 220 is disposed within the controller 42. The PDC connector temperature manager 220 may include an underhood air temperature module 222. The underhood air temperature module 222 determines the underhood air temperature based upon various sensors. The oil temperature sensor 210B, the radiator fan speed sensor 210C and the vehicle speed sensor 210D may all provide signals to determine the underhood temperature at the underhood air temperature module 222. The oil temperature signal, the radiator fan speed signal and the vehicle speed signal may all be used to determine an underhood air temperature. The underhood air temperature is determined based upon a model corresponding to the design of the particular vehicle and may be calibrated during vehicle development.

An exhaust surface temperature module 224 may be coupled to the vehicle speed sensor 210D, an exhaust gas temperature sensor 210E and an air temperature sensor 210F. The signals from the sensors 210D-210F may be used to generate the exhaust surface temperature based on a model developed during the development of the vehicle.

The underhood air temperature module 222 is in communication with the PDC surface look-up surface 226. The PDC surface look-up surface 226 may generate the power distribution center temperature of one or more of the connectors 60A-60C of the power distribution center. The power distribution center 40 may use the current from the PDC current sensor 210A in combination with the underhood air temperature determined at the underhood air temperature module 222 to determine the connector surface temperature.

An exhaust radiation look-up surface 228 may generate the exhaust radiation from the exhaust surface temperature module 224.

A summing block 230 may sum the output of PDC surface look-up surface 226 and the exhaust radiation look-up surface 228 to generate the controller temperature. An air dam adjustment module 232 together with the output of the summing block 230 generates a control signal at the summing block 234. The control signal from block 234 is used in comparison with a power distribution center connector temperature limit at the difference block 236 to generate an air dam control signal that is used to control an amount of opening or closing of the air dam actuator 240. The air dam actuator 240 may control the louvers 58 illustrated in FIG. 1B. The air dam actuator 240 may be a motor or another type of device that moves the louvers 58 from an open to a closed position or from a closed position to an open position or different positions therebetween based on the desired cooling needed from air dam.

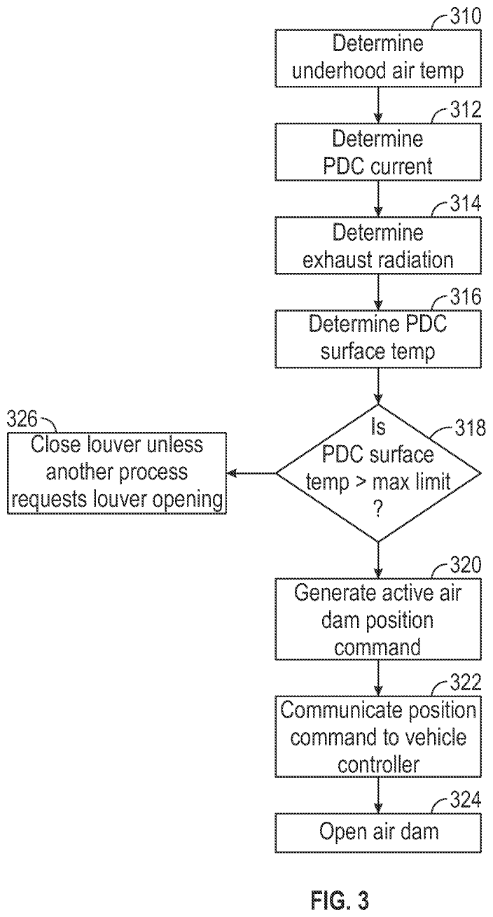

Referring now to FIG. 3, a method for operating the controller 42 and controlling an air dam actuator 240 is set forth. In step 310, the underhood air temperature is determined as set forth relative to the module 222 above. In step 312, the power distribution center current is determined from the power distribution current sensor 210A described above. In step 314, the exhaust radiation is determined. The power distribution center surface temperature is determined in step 316 from the underhood air temperature, the power distribution current and the exhaust radiation. The power distribution center surface temperature is compared to a temperature threshold in step 318. If the temperature is greater than the maximum temperature limit threshold, an active air dam position command is generated in step 320. In step 322, the vehicle controller 42 may communicate the position command to an air dam actuator. In step 324, the air dam may be actuated to the desired position. That is, when the temperature is greater than the maximum limit, the air dam may be opened in step 324.

When the temperature is not above the maximum temperature limit threshold (temperature threshold) in step 318, step 326 closes the air dam unless another process is requesting the air dam remain open. That is, other processes in the vehicle may open the air dam. The vehicle controller may communicate an air dam closed signal that is communicated to the air dam to close the air dam by controlling the actuator unless another process wants the air dam to remain open. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of controlling a vehicle comprising:
determining a temperature of a power distribution center; and
controlling an opening of an active air dam in response to the temperature of the power distribution center.

2. The method of claim 1 further comprising comparing the temperature of the power distribution center to a temperature threshold and opening the active air dam based when the temperature is above the threshold.

3. The method of claim 2 further comprising, when the temperature is below the threshold, closing the active air dam.

4. The method of claim 1 wherein determining the temperature of the power distribution center comprises determining the temperature of a power distribution center connector.

5. The method of claim 1 wherein determining the temperature of the power distribution center comprises determining the temperature based on exhaust radiation.

6. The method of claim 5 further comprising determining exhaust radiation based on an exhaust surface temperature.

7. The method of claim 6 further comprising determining the exhaust surface temperature in response to a vehicle speed and an exhaust gas temperature.

8. The method of claim 6 further comprising determining the exhaust surface temperature in response to a vehicle speed, an exhaust gas temperature and an air temperature.

9. The method of claim 1 wherein determining the temperature of the power distribution center comprises determining the temperature based on a power distribution center surface temperature.

10. The method of claim 9 wherein determining the temperature based on the power distribution center surface temperature comprises determining the temperature based on an underhood air temperature.

11. The method of claim 9 wherein determining the temperature based on the power distribution center surface temperature comprises determining the temperature based on an underhood air temperature and an electrical current through the power distribution center.

12. The method of claim 11 further comprising determining the underhood air temperature based on an oil temperature, a radiator fan speed and a vehicle speed.

13. A control system for controlling an active air dam, the control system comprising:
a power distribution center; and
a controller operable to:
determine a temperature of the power distribution center; and
control an opening of the active air dam in response to the temperature of the power distribution center.

14. The control system of claim 13 wherein the controller is operable to:
compare the temperature of the power distribution center to a temperature threshold and open the active air dam based when the temperature is above the temperature threshold and close the active air dam when the temperature is below the temperature threshold.

15. The control system of claim 13 wherein the power distribution center comprises a power distribution system center connector and wherein the controller is operable to determine the temperature of the power distribution center comprises by determining the temperature of a power distribution center connector.

16. The control system of claim 15 wherein the controller is operable to determine the temperature of the power distribution center by determining the temperature based on exhaust radiation and a power distribution center surface temperature.

17. The control system of claim 16 wherein the controller is operable to determine the power distribution center surface temperature by determining an exhaust surface temperature in response to a vehicle speed and an exhaust gas temperature.

18. The control system of claim 16 wherein the controller is operable to determine the power distribution center surface temperature based on an underhood air temperature.

19. The control system of claim 16 wherein the controller is operable to determine the power distribution center surface temperature based on an underhood air temperature and an electrical current through the power distribution center.

20. The control system of claim 19 wherein the controller is operable to determine the underhood air temperature based on an oil temperature, a radiator fan speed and a vehicle speed.
